(19) United States
(12) Patent Application Publication
(10) Pub. No.: US 2025/0226777 A1
(43) Pub. Date: Jul. 10, 2025

(54) Current Symmetry Control

(71) Applicant: B&R INDUSTRIAL AUTOMATION GMBH, Eggelsberg (AT)

(72) Inventors: Andreas Weber, Eggelsberg (AT); Stefan Brucker, Eggelsberg (AT)

(21) Appl. No.: 18/724,277

(22) PCT Filed: Dec. 23, 2022
(86) PCT No.: PCT/EP22/87756

§ 371 Date: Jun. 26, 2024

(30) Foreign Application Priority Data
Dec. 27, 2021 (AT) A51047/2021

(51) Int. Cl. H02P 6/28; H02P 6/00

(52) U.S. Cl. CPC H02P 6/28; H02P 6/006

(57) ABSTRACT

A method for operating an electromagnetic transport device is provided. According to the method, an area sum current is determined for a neutral point area of the long stator of the transport device, and a compensation current is fed into at least one active drive coil of the long stator such that a deviation of the area sum current from a predefined area sum current setpoint is reduced.

### CROSS-REFERENCE TO RELATED APPLICATIONS

This application is a National Stage Entry of International Patent Application No. PCT/EP2022/087756, filed Dec. 23, 2022, and titled “CURRENT SYMMETRY REGULATION”, which claims priority to Austrian Patent Application No. A51047/2021, filed Dec. 27, 2021, and titled “CURRENT SYMMETRY REGULATION”, each of which are hereby incorporated by reference in their entirety.

### BACKGROUND

Long stator linear motors (LLM) and planar motors (PM), their applications and their mode of operation are well known from the prior art. LLMs generally consist of a long stator (also known as a “long stator linear motor stator” or “LLM stator”) and at least one transport unit (also known as a “shuttle” or “mover”). As described, for example, in U.S. Pat. No. 6,876,107 B2, an LLM stator is usually composed of a large number of stator segments, wherein a large number of drive coils (also “LLM coils”) is arranged in a fixed position next to one another on the stator segments. The stator segments can have different geometries, such as straight lines, curves, switches, and can be assembled by lining them up to form the desired LLM stator. Thus, the LLM stator forms a conveyor line along which one or more transport units can be moved. The transport units are held and guided along the conveyor line.

Also planar motors (PMs) are known in the prior art. For example, U.S. Pat. No. 9,202,719 B2 discloses the basic structure and mode of operation of a PM. A PM substantially also has a long stator, but in the case of a PM this forms a transport plane in which one or more transport units can be moved at least two-dimensionally. With a PM, drive coils are usually arranged in the transport plane.

In order to bring about the movement of a transport unit in a controlled manner and to regulate and/or control it, drive magnets (permanent magnets or electromagnets) are arranged on a transport unit in addition to the drive coils arranged on the long stator. By selectively controlling the drive coils, which can be effected in particular by applying a corresponding coil voltage to generate a drive current in the drive coils, a moving magnetic field, a so-called magnetic drive field, can be generated, which interacts with the drive magnets of the transport unit to move the transport unit. Drive coils that are controlled, i.e. energized, for the purpose of generating a magnetic drive field are referred to here and also in the course of the following embodiments as “active” drive coils. A transport unit can thus be moved in the direction of the moving magnetic drive field. A large number of transport units can also be moved independently of one another along a conveyor line in the manner described. Further embodiments in this regard can be found in WO 2013/143783 A1, WO 98/50760 A2, U.S. Pat. No. 6,876,107 B2, US 2013/0074724 A1, or EP 1 270 311 B1.

One option for applying a coil voltage to a drive coil to control/energize it is, for example, to use a full bridge per drive coil, as disclosed in US 2006/0220623 A1. An operating voltage that drops between a first operating potential and a second operating potential is applied in each case to the first branch and the second branch of the full bridge respectively, and the drive coil is connected to the cross branch of the full bridge. A desired coil voltage can be applied to the drive coils by suitable control of the four switches (for example, bipolar transistors, MOSFETs, IGBTs, etc.) of the full bridge.

With a naturally high number of drive coils, the use of full bridges results in high costs and a high level of circuit complexity. For this reason, EP 3 385 110 A1, for example, describes the use of half bridges to control drive coils. The center points of the half bridges provided for the drive coils are in each case connected to the first terminal of a drive coil. In contrast, the second connections of drive coils combined into groups in each case are connected together to form a common neutral point. In many practically relevant embodiments, the drive coils that in each case are assigned to a stator segment of a long stator are connected together at a neutral point.

However, it is also conceivable that when using half bridges to control drive coils, drive coils from different stator segments also have a common neutral point, i.e. that a group of drive coils also comprises drive coils from different stator segments, and that the second connections of drive coils from different stator segments are therefore also connected together to form a common neutral point. The geometric area of a long stator in which the drive coils are arranged with a common neutral point is referred to as the “neutral point area.”

The electric potential of a neutral point is about halfway between the first operating potential, which is present at the input of the half bridges provided, and the second operating potential, which is present at the output of the half bridges provided. In this manner, in each case half the operating voltage drops across the switches of the half bridges. To set the coil voltages, a large number of methods for switching the switches of the half bridges, such as pulse width modulation (PWM), which is well known from the relevant literature, can be used in an advantageous manner.

However, a prerequisite for the use of PWM to control drive coils using half bridges, for example, is that the electric potentials of the neutral points to which the second connections of the drive coils are connected are (at least approximately) constant. A constant potential is usually established at the aforementioned neutral points if the sum of the currents flowing through the drive coils connected together in a neutral point during operation is kept at zero. This state is referred to as symmetrical current supply of a neutral point. Specifically, the terms “symmetrical current flow” of a stator segment or a neutral point area or “current symmetry” in a stator segment or in a neutral point area are also commonly used. If the same voltage drops across the switches of a half bridge, this is also referred to as symmetrical PWM.

For various reasons, however, the aforementioned current symmetry may be lost during operation of an LLM or a PM. This means that it is sometimes not possible to use the number of drive coils required for symmetrical current flow of a neutral point. The reasons for this may be that a transport unit is in the transition from a first stator segment or neutral point area to a second stator segment or neutral point area, wherein the active drive coils involved in generating the magnetic drive field in the first and second stator segment or neutral point area are controlled such that an asymmetrical current flow arises in the corresponding neutral points.

The problem of asymmetric currents in neutral points of a long stator of an LLM or a PM is known in the prior art. For example, EP 3 461 677 B1 describes the generation/setting of a constant center bus voltage in a linear motor system. The setting of a center bus voltage corresponds to the setting of the potential at the neutral point of a stator segment. In the aforementioned EP 3 461 677 B1, only so-called “free,” i.e. inactive, drive coils are energized with a compensation current to generate/set center bus voltages. Free drive coils are drive coils that are not energized with a drive current to generate a magnetic drive field.

An obvious and significant disadvantage of the concept known from EP 3 461 677 B1 is that inactive drive coils must be present for its implementation. However, this cannot always be guaranteed. In such cases, the approach disclosed in EP 3 461 677 B1 cannot be applied.

Therefore, it is an object of the present disclosure to provide a method for current symmetrization in the long stator of a long stator linear or planar motor that is improved over the prior art.

### BRIEF DESCRIPTION

This object is achieved via the features of the independent claims of the present disclosure. For an electromagnetic transport device having a long stator, on which a plurality of electric drive coils is arranged, and having a number k of transport units movable along the long stator, on which transport units in each case a plurality of excitation magnets is arranged, wherein an electrical coil current is fed in each case into a number q of active drive coils of the plurality of electric drive coils, which are involved in the movement of at least one transport unit, in order to generate a magnetic drive field, which interacts with the drive magnets of the at least one transport unit, in order to move the at least one transport unit, for at least one neutral point area of the long stator, in which at least one active drive coil is arranged and in which the coil currents flowing through the drive coils of the neutral point area converge in a neutral point, an area sum current is determined which corresponds to the sum of the coil currents flowing through the drive coils of the neutral point area.

Based on this, according to the disclosure, a compensation current is fed into at least one active drive coil of the at least one neutral point area in addition to the coil current already flowing in the active drive coil, such that a deviation of the area sum current from a predefined area sum current setpoint is reduced. The decisive factor here is that, in contrast to the prior art, active drive coils are used to take in a compensation current.

In an advantageous manner, a value that is less than 10 A, or less than 1 A, or less than 0.1 A can be predefined for the area sum current setpoint. In some embodiments, the area sum current setpoint is selected as a positive value less than 10 A, or less than 1 A, or less than 0.1 A, so that negative values for the area sum current setpoint are excluded. In an advantageous manner, values can also be predefined for the area sum current setpoint whose absolute value is smaller than 10 A, or smaller than 1 A, or smaller than 0.1 A, so that negative values for the area sum current setpoint are possible, but these are limited in terms of their absolute value by the predefined value. The selection of a value of 0 A for the area sum current setpoint is desirable. If the area sum current assumes an area sum current setpoint of 0 A, perfect current symmetry is achieved.

If it is ensured, as by the present disclosure, that the area sum current is as close as possible to a suitably selected area sum current setpoint, or that the area sum current is ideally equal to the suitably selected area sum current setpoint, the disadvantages associated with asymmetrical current supply of neutral points, which can arise in the operation of an electromagnetic transport device such as an LLM or a PM, can be avoided. As mentioned, the electromagnetic transport device can be an LLM or a PM. By symmetrizing the currents flowing into the neutral points of the long stator, the operating behavior can be significantly improved in some cases, in particular when using PWM to control the drive coils.

In an advantageous embodiment of the present disclosure, the (coil-specific) compensation current introduced into the at least one active drive coil is determined by initially identifying a total sum compensation current from the total area sum current, from which sum compensation current the coil-specific compensation current is specified in a further step. In this manner, the problem, to be solved, of determining a compensation current is divided into two sub-problems, each of which is easier to solve than the direct determination of a coil-specific compensation current. However, it is also possible to determine a coil-specific compensation current directly. By considering the entire area sum current, it is also easy to determine exactly how much compensation current must be provided in total in order to achieve current symmetry in a neutral point.

The determination of the sum compensation current described can be achieved in an advantageous manner based on a predefined controller from the determined area sum current, wherein various methods of control engineering can be used, such as model predictive control (MPC) or sliding mode control (SMC), or other linear or non-linear control methods. The predefined area sum current setpoint and the area sum current can be fed into the controller and the sum compensation current required for symmetrizing the currents in the neutral point can be output by the controller. In this manner, the advantages of the aforementioned control methods can be utilized, such as a finite convergence time in the case of sliding mode control (SMC) when setting the sum compensation current, or the consideration of future influences on the currents flowing into the neutral point, such as future changes in the speed of a transport unit, in the case of model predictive control (MPC). It turns out that the use of an integrating component in the control methods described is advantageous in many cases, on the one hand to be able to suppress disturbances, on the other hand to continue to output a sum compensation current even in the case of perfect symmetrization of the currents in the neutral point, i.e., if the area sum current is equal to the area sum current setpoint, in order to maintain the state of symmetrization of the currents in the neutral point.

When actually supplying the subordinate, coil-specific compensation current, care must be taken in practical implementation to ensure that the movements of the transport units in the electromagnetic transport device are only influenced as slightly as possible. Within the framework of the present disclosure, this can be achieved in an advantageous manner by feeding the compensation current into the at least one active drive coil by means of a sequence of high-frequency current pulses. The aforementioned high-frequency current pulses can be determined from the compensation current. One option for this is to select the high-frequency current pulses to be fed such that the high-frequency current pulses generate or sweep over the same current-time area as the course of the predefined compensation current within a predefined time interval. It has been found that if the coil-specific compensation currents are predefined in the form of high-frequency current pulses, the inertia of the transport units results in only minor influences on the movement profile of the transport units. In various embodiments, the high-frequency current pulses have a frequency greater than 100 Hz, or a frequency greater than 500 Hz, or a frequency greater than 1 kHz, or a frequency greater than 5 kHz, or a frequency greater than 10 kHz. The amplitudes of the current pulses can be the same or variable.

It is also possible to feed the compensation current out of phase with the coil current already flowing in the at least one active drive coil, which also ensures that the compensation current has only a minor effect on the resulting propulsive forces. In many cases, the coil currents fed into the drive coils are present as sinusoidal current curves. If a compensation current is also predefined as a sinusoidal current curve in such a case, a desired phase shift between compensation current and coil current can be achieved, as is well known from electrical engineering, by specifying a suitable time offset between the respective oscillation valleys or the respective oscillation maxima of the respective sinusoidal current curves of coil current and compensation current. In an advantageous manner, this phase shift is at least 45 degrees, but may be at least 60 degrees, or at least 80 degrees.

A further advantage of using drive coils already used to generate a magnetic drive field is that such drive coils are always available. If, in comparison, only free drive coils of a stator segment were used, there would be no drive coil for current symmetrization if a stator segment were fully occupied with transport units (for example, transport unit end to end covering a stator segment), and there would be no possibility of current symmetrization in the stator segment.

The method according to the disclosure can generally be applied to drive systems in the form of segmented, long stator linear motors and planar motors. In a minimal implementation, a single stator segment is sufficient. The actual number of stator segments is irrelevant for the application of the method according to the disclosure, as is the specific number or the specific arrangement of the drive coils on a stator segment.

### BRIEF DESCRIPTION OF THE DRAWINGS

The present disclosure is explained in more detail below with reference to FIGS. 1 to 6, which show exemplary, schematic and non-limiting advantageous embodiments of the disclosure. In the figures:

FIG. 1 shows a long stator linear motor with stator, stator segments and transport units movable along the long stator,

FIG. 2 shows the control of drive coils of a stator segment using half bridges,

FIG. 3a, FIG. 3b, FIG. 3c show a movement profile of a transport unit from a first stator segment to a second stator segment,

FIG. 4 shows a superordinate control circuit for current symmetrization,

FIG. 5 shows the introduction of compensation currents using current pulses, and

FIG. 6 shows a subordinate control circuit for regulating the coil current in a drive coil.

### DETAILED DESCRIPTION

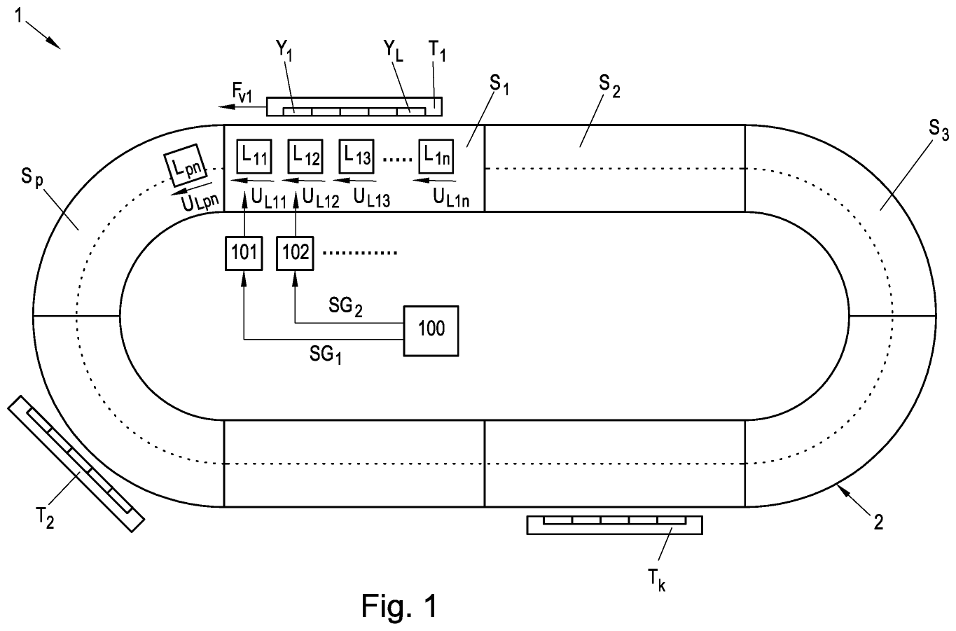

FIG. 1 shows by way of example a transport device 1 in the form of a long stator linear motor (LLM). The LLM 1 consists of a plurality of separate stator segments S₁, . . . , Sₚ, which are subsequently referenced by means of Sₘ (with m≥1 as the running index) and which are assembled to form a stationary long stator 2 of the LLM 1. The stator segments S₁, . . . , Sₚ can be arranged on a stationary support structure (not shown in FIG. 1) for this purpose. Furthermore, the stator segments S₁, . . . , Sₚ, as also shown in FIG. 1, can be designed in different geometric shapes, for example as straight segments or curved segments, in order to be able to realize different transport paths.

Electrical drive coils Lₘ₁, . . . , Lₘₙ are arranged along the long stator 2 in a known manner for each stator segment Sₘ in the longitudinal direction (shown in FIG. 1 only for the stator segment S₁, n is an integer greater than one), which interact with drive magnets Y₁, . . . , Y_{L} of the number k of transport units T₁, . . . , Tₖ (referred to below as Tᵣ). In an equally well-known manner, based on coil control units 101, 102, a propulsive force Fᵥᵣ for each of the transport units T₁, . . . , Tₖ is generated by controlling/setting coil voltages U_{L1}, . . . , U_{Ln} dropping across the drive coils Lₘ₁, . . . , Lₘₙ, in order to move the transport units T₁, . . . , Tₖ along the long stator 2. As a rule, a plurality of drive coils Lₘ₁, . . . , Lₘₙ act simultaneously on a transport unit T₁, . . . , Tₖ, which together generate the propulsive force Fᵥᵣ. For reasons of clarity, only two coil control units 101, 102 are shown in FIG. 1. Of course, each coil voltage U_{L1}, . . . , U_{Ln} of each drive coil Lₘ₁, . . . , Lₘₙ in each stator segment Sₘ is controlled by a coil control unit 101, 102, wherein a plurality of coil control units 101, 102 can also be combined into one control unit. Possible implementations of a coil control unit 101, 102 include microprocessor-based hardware, such as microcontrollers and integrated circuits (ASIC, FPGA).

In the embodiment of an LLM 1 shown in FIG. 1, each of the transport units T₁, . . . , Tₖ can be moved individually (speed, acceleration, path, direction) and independently (except for the avoidance of possible collisions) of the other transport units T₁, . . . , Tₖ by means of a transport controller 100 that is superordinate to the coil control units 101, 102. For this purpose, the transport controller 100 can continuously predefine a position specification (equivalently also a speed specification) for each transport unit T₁, . . . , Tₖ to be moved, which is converted by the coil control units 101, 102 into coil voltages U_{L11}, . . . , U_{Lpn} required for the movement of the transport unit T₁, . . . , Tₖ. The coil control units 101, 10n receive setpoints SG₁, . . . , SGₙ from the transport controller 100 for control. Since this basic principle of an LLM is sufficiently well known, it will not be discussed in detail here.

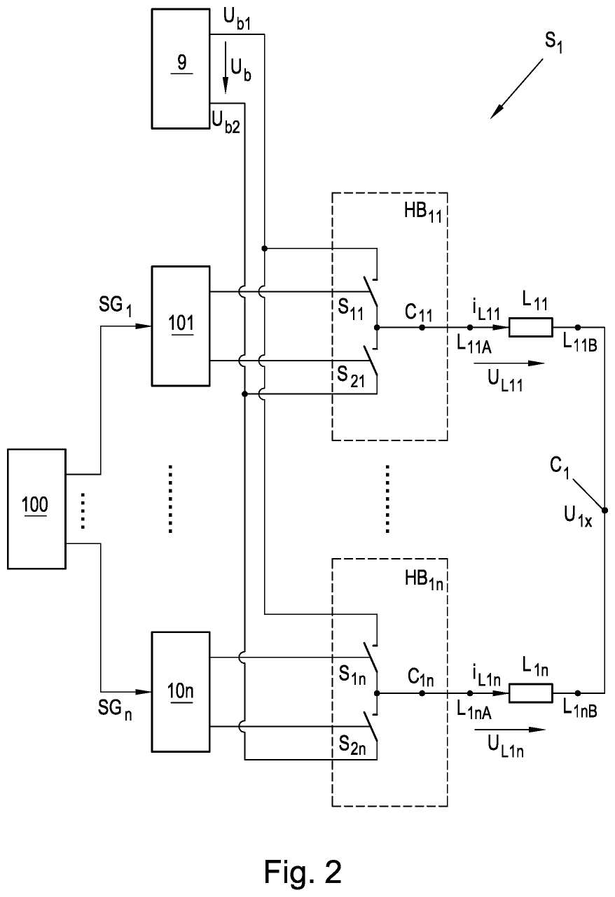

FIG. 2 further shows how drive coils L₁₁, . . . , L₁ₙ can in each case be controlled in an exemplarily selected stator segment S₁ by means of an assigned half bridge HB₁₁, . . . , HB₁ₙ. The following embodiments apply to all stator segments S₁, . . . , Sₚ. For an LLM 1 with a plurality of stator segments S₁, . . . , Sₚ, which in turn comprise a plurality of drive coils Lₘ₁, . . . , Lₘₙ, a plurality of circuits such as the circuit shown in FIG. 2 are accordingly required.

To supply the half bridges HB₁₁, . . . , HB₁ₙ in the situation shown in FIG. 2, a voltage source 9 is provided, which can be implemented in the form of a rectifier, for example, and which provides the half bridges HB₁₁, . . . , HB₁ₙ with a first operating potential U_{b1} and a second operating potential U_{b2}. The half bridges HB₁₁, . . . , HB₁ₙ each comprise a main branch, which consists of two switches S₁₁, S₂₁. The operating voltage U_{b}, which is formed by the difference between the first operating potential U_{b1} and the second operating potential U_{b2} at the input terminals of the half bridges HB₁₁, . . . , HB₁ₙ, is applied to the series connection of the switches S₁₁, S₂₁.

The respective connection point between first switches S₁₁, . . . . S₁ₙ and second switches S₂₁, . . . , S₂ₙ is referred to as the center point C₁₁, . . . , C₁ₙ and in each case is connected to a first terminal L_{11A}, . . . , L_{1nA} of a drive coil L₁₁, . . . , L₁ₙ. The second connections L_{11B}, . . . , L_{1nB} of the drive coils L₁₁, . . . , L₁ₙ of the stator segment S₁ are also connected to the neutral point C₁ and are therefore at the common electrical center potential U₁ₓ (generally Uₘₓ). The neutral points Cₘ of different stator segments S₁, . . . , Sₚ are not connected to one another, for circuitry reasons among other reasons.

The drive coils L₁₁, . . . , L₁ₙ shown in FIG. 2 therefore define a neutral point area, i.e., a geometric area of the long stator 2 in which drive coils L₁₁, . . . , L₁ₙ are arranged with the common neutral point C₁. As mentioned, drive coils Lₘ₁, . . . , Lₘₙ with a common neutral point Cₘ do not generally have to be assigned exclusively to a single, common stator segment Sₘ. In fact, it is also possible that the drive coils Lₘ₁, . . . , Lₘₙ from different stator segments S₁, . . . , Sₚ have a common neutral point Cₘ and accordingly define a neutral point area that extends over a plurality of stator segments S₁, . . . , Sₚ.

Specifically, in the case shown in FIG. 2, the control of switches S₁₁, . . . , S₁ₙ, S₂₁, . . . , S₂ₙ comprises the sequence of two switch positions (usually “1” . . . closed, “0” . . . open). In the first switch position, in each case the first switch S₁₁, . . . , S₁ₙ is closed and in each case the second switch S₂₁, . . . , S₂ₙ is open, wherein the coil voltages U_{L11}, . . . , U_{L1n} result from the difference between the first operating potential U_{b1} and the center potential U₁ₓ, e.g. U_{L1}=U_{b1}−U₁ₓ. In the second switch position, the first switch S₁₁, . . . , S₁ₙ is open and the second switch S₂₁, . . . , S₂ₙ is closed, wherein the coil voltages U_{L11}, . . . , U_{L1n} result from the difference between the center potential U₁ₓ and the second operating potential U_{b2}, e.g. U_{L1}=U₁ₓ−U_{b2}. It is clear that different polarities of the coil voltages U_{L11}, . . . , U_{L1n} can be realized by different switch positions. In the special case that the second operating potential U_{b2} is at ground (U_{b2}=0) and that the predefined center potential U₁ₓ corresponds to half the operating voltage U_{b} (U₁ₓ=U_{b}/2), the first switch position results in a coil voltage U_{L1} of U_{b}/2 and the second switch position results in a coil voltage U_{L1} of −U_{b}/2.

If the coil voltages U_{L11}, . . . , U_{L1n} are controlled independently of one another, each drive coil L₁₁, . . . , L₁ₙ (in general) has a different coil voltage U_{L11}, . . . , U_{L1n}. If a coil voltage U_{L11}, . . . , U_{L1n} is positive, a coil current i_{L11}, . . . , i_{L1n} flows from the relevant drive coil L₁₁, . . . , L₁ₙ into the neutral point C₁ and the center potential U₁ₓ. However, if a coil voltage U_{L11}, . . . , U_{L1n} is negative, a coil current i_{L11}, . . . , i_{L1n} flows out of the neutral point C₁ into the relevant drive coil L₁₁, . . . , L₁ₙ and the center potential U₁ₓ. A non-zero sum current I_{1Σ}=Σ_{K=1}ⁿ i_{L1K} across the coil currents i_{L11}, . . . , i_{L1n} of the stator segment S₁ or a neutral point area in general results in a rise or fall of the center potential U₁ₓ. A current sum I_{mΣ}=Σ_{K=1}ⁿ i_{LmK} for a segment Sₘ is referred to in particular as the “area sum current” in the following embodiments. A rise or fall in the center potential U₁ₓ is also referred to as a “warping” or “distortion” of the center potential U₁ₓ. Such a warping of the center potential U₁ₓ can have a particularly negative effect on the operation of an LLM 1, as mentioned at the beginning.

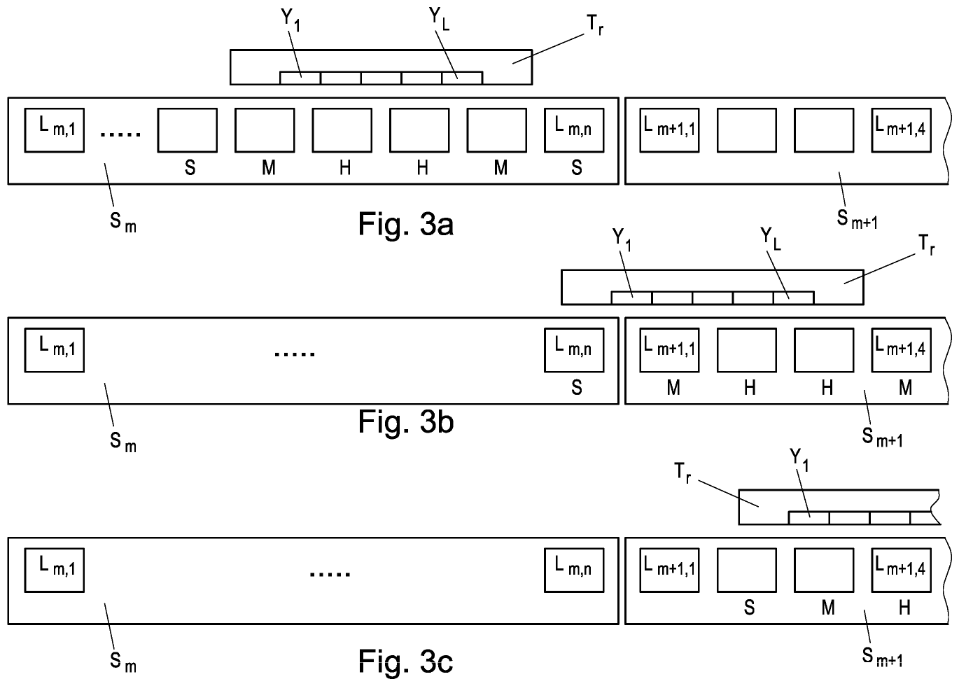

The fact that distortions of a center potential Uₘₓ such as the U₁ₓ shown in FIG. 2 can arise during the operation of an LLM 1 for a plurality of reasons is explained in more detail in the following by means of FIG. 3. FIG. 3 shows a transport unit Tᵣ, which is initially located entirely above the stator segment Sₘ in FIG. 3a. In the case shown in FIG. 3a, the stator segments Sₘ, Sₘ₊₁ define the substantial neutral point areas for the present disclosure. The active drive coils Lₘ₁, . . . , Lₘₙ used to generate a magnetic drive field are labeled with the letters S, H, M. Specifically, in the present case a number of q=6 active drive coils are used to generate the magnetic drive field. Drive coils that are fully covered by the transport unit Tᵣ are designated H, partially covered drive coils Lₘ₁, . . . , Lₘₙ are designated M and drive coils Lₘ₁, . . . , Lₘₙ that are not covered but are also used to generate force are designated S. It should be mentioned at this point that in a plurality of cases that are relevant in practice, some of the aforementioned S drive coils may not be present. A relevant case in this respect is when two transport units Tᵣ are moved end to end.

In FIG. 3b, the transport unit Tᵣ has reached the boundary between the stator segments Sₘ, Sₘ₊₁ shown and is therefore partly in the first stator segment Sₘ and partly in the following, second stator segment Sₘ₊₁. In the situation shown in FIG. 3b, the transport unit Tᵣ only covers the last LMM coil Lₘₙ of the stator segment Sₘ. If, as in many drive concepts for LLM known from the prior art, only the drive coils covered by a transport unit Tᵣ are energized, only the last drive coil Lₘₙ is energized in the stator segment Sₘ in the situation shown in FIG. 3b. The sum current I_{mΣ}=Σ_{K=1}ⁿ i_{LmK} across the entire stator segment Sₘ can no longer disappear in such a case, which is why the center potential Uₘₓ in the stator segment Sₘ is distorted as described in the embodiments above. In abstract terms, the number of drive coils required for symmetrical control cannot be used in the situation shown in FIG. 3b.

In FIG. 3c, the transport unit Tᵣ has finally been completely transferred to the stator segment Sₘ₊₁, so that only the drive coils of the second stator segment Sₘ₊₁ need to be energized to move the transport unit Tᵣ. Therefore, all active drive coils are located in the stator segment Sₘ₊₁. There is now no further distortion of the center potential Uₘₓ in the stator segment Sₘ due to the principle.

Generally speaking, due to the geometry of an LLM 1 (structure of the magnets and coils), sensible so-called “symmetric coil systems” emerge. An example of this is the 3-coil system, as is well known from electrical rotating field machines, with which there is always a number of q=3 active drive coils. With the movement sequence shown in FIGS. 3a to 3c, a 6-phase system is used (use of the drive coils S-H-M-M-H-S to generate force, i.e., q=6 active drive coils). If a transport unit Tᵣ now enters or leaves a stator segment Sₘ and thus a neutral point area, the number of drive coils Lₘ₁, . . . , Lₘₙ required for symmetrical current flow can no longer be used.

In addition to this scenario, which can lead to a distortion of the center potential Uₘₓ, there are other possible causes. It can happen that transport units Tᵣ come so close together that drive coils Lₘ₁, . . . , Lₘₙ have to be assigned twice or have to be blocked for a transport unit Tᵣ. Also in such cases, the use of a symmetrical number of drive coils Lₘ₁, . . . , Lₘₙ is not always ensured. Furthermore, phase shifts in the current control for controlling the coil currents i_{Lm1}, . . . , i_{Lmn} can lead to an asymmetrical current flow. Saturation effects of the electrical components installed in an LLM 1, in particular the installed drive coils Lₘ₁, . . . , Lₘₙ, can also result in asymmetrical current flow of a stator segment Sₘ.

If, as already explained, the principle of symmetrical PWM is used to control switches such as the switches S₁₁, . . . , S₁ₙ and S₂₁, . . . , S₂ₙ shown in FIG. 2, the voltages across the switches S₁₁, . . . , S₁ₙ and S₂₁, . . . , S₂ₙ are usually assumed to be constant voltages. The control times, i.e. opening and closing times, for the switches S₁₁, . . . , S₂ₙ are specified as a function of these (constant) voltages. If the voltages actually dropping at the switches S₁₁, . . . , S₂ₙ deviate from the assumed (constant) voltages due to a warping of the center potential U₁ₓ, errors may occur in the switching times specified for the switches S₁₁, . . . , S₁ₙ and S₂₁, . . . , S₂ₙ, thus leading to errors in the coil currents i_{L11}, . . . , i_{L1n} to be set, thus leading to errors in the resulting magnetic drive field, and thus impairing the overall operation of an LLM 1.

For these reasons, the present disclosure counteracts a distortion of the center potential Uₘₓ, wherein, in simple terms, it is ensured that the total current flowing to a neutral point Cₘ across drive coils Lₘ₁, . . . , Lₘₙ and the total current flowing away from a neutral point Cₘ are equal. However, in contrast to the known prior art, active drive coils Lₘ₁, . . . , Lₘₙ are also used for symmetrizing the area sum currents, i.e. also drive coils Lₘ₁, . . . , Lₘₙ, which are also used at the same time to form propulsive forces Fᵥᵣ acting on the transport units Tᵣ.

For this purpose, according to the disclosure, for at least one stator segment Sₘ, as shown in FIG. 1, 2 or 3a-3c, an area sum current I_{mΣ}=Σ_{K=1}ⁿ i_{LmK} corresponding to the sum of these coil currents i_{Lm1}, . . . , i_{Lmn} is determined by adding the coil currents i_{Lm1}, . . . , i_{Lmn}, which flow in the drive coils Lₘ₁, . . . , Lₘₙ of this at least one stator segment Sm. Instead of the present stator segment Sₘ, a wider neutral point area can also be used, as explained several times, which can extend over a plurality of stator segments, for example. However, the following embodiments are valid for a single stator segment Sₘ, as well as for a general, wider neutral point area.

This area sum current I_{mΣ} represents the current sum for the stator segment Sₘ that must be brought to zero according to the above embodiments in order to ensure a constant center potential Uₓₘ. In order to achieve this objective, a compensation current i_{Kompx} is fed into at least one drive coil Lₘₓ of the at least one stator segment Sₘ involved in the movement of the transport unit Tᵣ in addition to the drive current i_{Lmx} already flowing there. Therefore, this compensation current i_{Kompx} becomes a component of the area sum current I_{mΣ}, for which I_{mΣ}=Σ_{K=1}ⁿ i_{LmK}+i_{Komp,x} now applies. According to the disclosure, the compensation current i_{Kompx} is designed such that it reduces the deviation in the area sum current I_{mΣ}, which now also includes the additional compensation current i_{Kompx}, from a predefined area sum current setpoint I_{1Σ}*. In an embodiment, the area sum current setpoint I_{1Σ}* can of course be set to zero, in order to ensure the described objective of current symmetrization.

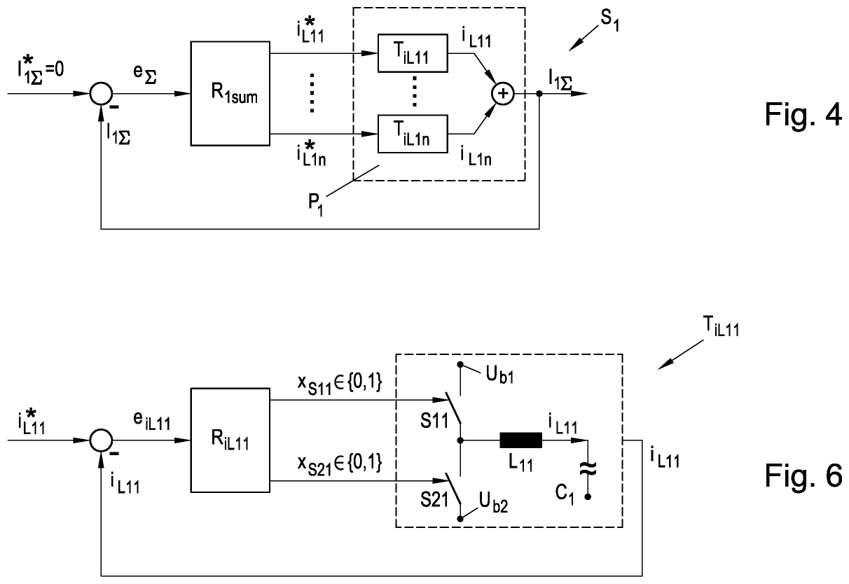

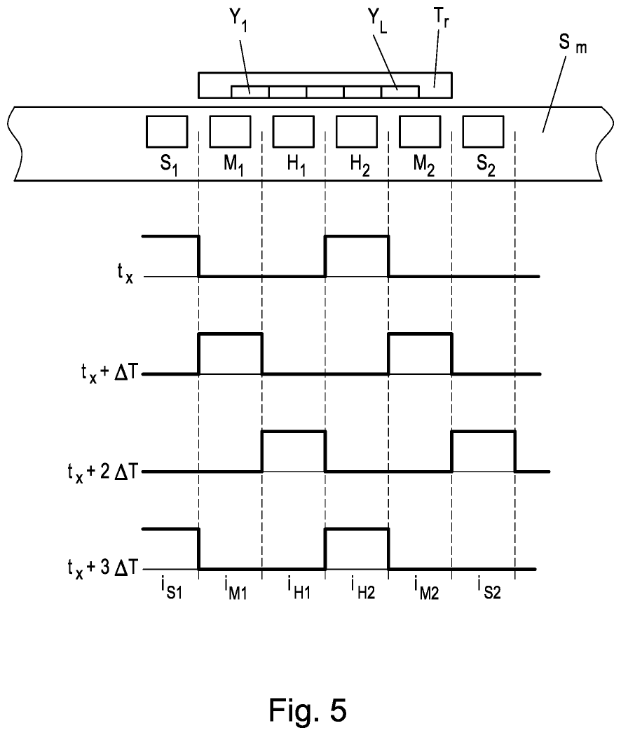

FIG. 4 and FIG. 5 show how these steps can be implemented in practice. FIG. 4 uses the stator segment S₁ as an example to show how a control circuit for controlling the area sum current I_{1Σ} to I_{1Σ}=0 can be structured. However, the present embodiments are generally valid for stator segments Sₘ as well as for more general neutral point areas of an LLM as shown in FIG. 1 or also of a PM.

On the one hand, FIG. 4 shows the controlled system P₁, which substantially consists of a stator segment Sₘ as shown in FIG. 2. The controlled system P₁ contains the blocks T_{iL11}, . . . , T_{iL1n}, which in each case represent closed control circuits for controlling the respective coil currents i_{L11}. The blocks T_{iL11}, . . . , T_{iL1n} receive setpoints i_{L11}*, . . . , i_{L1n}* for the coil currents and output the controlled coil currents i_{L11}, . . . , i_{L1n}, as is well known from control engineering. According to the disclosure, these coil currents i_{L11}, . . . , i_{L1n} are added up to form the area sum current I_{1Σ}. This area sum current I_{1Σ} is now fed back as usual in control engineering and compared with a predefined area sum current setpoint I_{1Σ}*. According to the previous embodiments, for this area sum current setpoint I_{1Σ}*=0 applies.

The control error e_{Σ}=I_{1Σ}*−I_{1Σ} formed from the difference between the area sum current setpoint I_{1Σ}* and the area sum current I_{1Σ} is further fed to the controller R₁ₛᵤₘ, as is usual in control engineering. In the case of the present LLM 1, the controller R₁ₛᵤₘ can, in a particularly advantageous manner, be implemented in the transport controller 100. Furthermore, the controller R₁ₛᵤₘ can be implemented as a PID controller, for example, whose control law can be mathematically expressed as

$${I}_{1 , KOMP}^{* ( t )} = {K}_{p} ( - {I}_{1 Σ} ) + {K}_{i} \int ( - {I}_{1 Σ} ) dt + {K}_{d} \frac{d ( - {I}_{1 Σ} )}{dt} .$$

Kₚ, Kᵢ and K_{d} stand for the controller parameters of the PID controller. The mathematical representation of the control law utilizes the fact that I_{1Σ}*=0 applies for the setpoint and that the setpoint I_{1Σ}* therefore disappears from the control law. I_{1,KOMP}* also stands for a sum compensation current that counteracts the deviation in the area sum current I_{1Σ} from zero. However, in addition to a PID controller, any other control approaches for implementing the present disclosure are also conceivable, such as approaches from the fields of sliding mode control, backstepping control or model predictive control. For the selection of the parameters Kₚ, Kᵢ and K_{d}, a large number of methods known from the control engineering literature can be used; reference is made here to the well-known Ziegler-Nichols method by way of example.

For the present disclosure, it is important at this point to calculate the sum compensation current I_{1,KOMP}* to a plurality of compensation currents i_{Kompx}, which are assigned to selected drive coils L₁₁, . . . , L₁ₙ of the stator segment S₁, and to control these compensation currents i_{Kompx} in the selected drive coils L₁₁, . . . , L₁ₙ. In FIG. 4, the allocation of compensation currents i_{Kompx} to the respective drive coils L₁₁, . . . , L₁ₙ is effected by transmitting the aforementioned setpoints i_{L11}*, . . . , i_{L1n}*, which in this case also comprise setpoint compensation currents i_{Kompx}* in addition to the drive currents required for the movement of the transport units Tᵣ.

In the embodiment of the disclosure shown in FIG. 4, this division of the compensation current I_{1,KOMP}* into compensation currents i_{Kompx} is already effected in the controller R₁ₛᵤₘ. However, it is also conceivable to divide and allocate in a division unit downstream of the controller R₁ₛᵤₘ.

The selection of the active drive coils L₁₁, . . . , L₁ₙ used for current symmetrization can be effected in different manners. For example, only H-drive coils or only M-drive coils or only S-drive coils can be used. Any combination of H-drive coils and/or M-drive coils and/or S-drive coils is also possible. H-drive coils and/or M-drive coils and/or S-drive coils can also be combined with free drive coils L₁₁, . . . , L₁ₙ. Itis substantial for the present disclosure that at least one active drive coil L₁₁, . . . , L₁ₙ is used for current symmetrization, which is also used to form a propulsive force Fᵥ on a transport unit Tᵣ. It is also important here that the influence on propulsive forces Fᵥᵣ, which act on the given transport units Tᵣ to move them, but also on the normal forces Fₙ (especially in switch areas, i.e. in the area of curved stator segments Sₘ) is kept low.

On the one hand, this can be achieved to a large extent by a suitable choice of drive coils L₁₁, . . . , L₁ₙ to take in compensation currents i_{Kompx}. For example, the influence on the force formation of S-drive coils is small and lies in the area of a few percent of the total propulsive force Fᵥᵣ generated. Alternatively, the same partial compensation current can also be applied to all occupied H-drive coils and/or M-drive coils and/or S-drive coils of a stator segment Sₘ, which corresponds to an offset displacement of the occupied drive coils L₁₁, . . . , L₁ₙ, but ultimately no resulting propulsive force Fᵥᵣ is generated.

Another option for introducing compensation currents i_{Kompx} is to introduce the compensation currents out of phase with the drive currents already flowing there such that only one of the force components Fᵥᵣ (longitudinal force) or Fₙᵣ (normal force) acting on the transport units Tᵣ is influenced. For example, the current can be introduced into the H-drive coils such that only the normal force Fₙᵣ is influenced. The generated propulsive forces Fᵥᵣ are not influenced in such cases.

A completely different option is to introduce the determined compensation currents into the selected drive coils L₁₁, . . . , L₁ₙ in the form of high-frequency current pulses. By using correspondingly high-frequency clocked current pulses, their effect on the movements of the transport units Tᵣ can be greatly dampened by the inertia of the transport units Tᵣ (masses of the respective transport units Tᵣ). In simple terms, high-frequency compensation currents i_{Kompx} are superimposed on the currents already flowing in the selected drive coils L₁₁, . . . , L₁ₙ, wherein these are distributed such that the resulting area sum current I_{1Σ} is brought closer to zero.

The introduction of a compensation current i_{Kompx} by means of current pulses is shown in more detail in FIG. 5. FIG. 5 shows a transport unit Tᵣ located above six coils S-H-M-M-H-S of a stator segment Sₘ. Four current supply situations are shown under the coils at the points in time tₓ, tₓ+ΔT, tₓ+2ΔT, tₓ+3ΔT. The compensation currents i_{Kompx} fed into the coils S-H-M-M-H-S are in each case shown within the dashed lines. As can be seen from the currents i_{S1}, i_{M1}, i_{H1}, i_{H2}, i_{M2}, i_{S2} listed along the abscissa, in the example shown, a current pulse is introduced into two drive coils at each point in time. Depending on the level of a sum compensation current I_{1,KOMP}* to be fed, the level of these current pulses can be adjusted. It is immediately apparent that if the transport unit Tᵣ moves quickly over the coils shown and if small values are selected for the time interval ΔT, high frequencies are generated for the current pulses, which only have a minor influence on the movement of the transport unit Tᵣ due to the mass of the transport unit Tᵣ.

Independent of the division and allocation of the compensation current I_{1,KOMP}*, the determined compensation currents i_{Kompx} must ultimately actually be controlled. One option in this respect is to pass on the determined compensation currents i_{Kompx} as part of current setpoints i_{L11}*, . . . , i_{L1n}* to subordinate, coil-specific current control circuits. In the case of an active drive coil Lₘₓ, such a current setpoint i_{L11}*, . . . , i_{L1n}* can comprise a setpoint for a coil current already flowing in the drive coil and now also a setpoint compensation current i_{Kompx}* as described above.

FIG. 6 shows by way of example how the control of such current setpoints i_{L11}*, . . . , i_{L1n}* can be implemented in specific terms. In the situation shown in FIG. 6, the transmitted setpoint i_{L11}* is compared to the current i_{L11} flowing in the coil L₁₁ and the control error e_{iL11} is formed by calculating the difference. This control error e_{iL11} is fed to the individual coil current controller R_{iL11}, which maps the control error to the firing or switching signals x_{S11} or x_{S12} for the switches S₁₁ or S₁₂ of the half bridge L₁₁ belonging to coil L₁₁. In the manner described, a previously determined compensation current i_{Kompx} (in the case of an active drive coil in addition to an already flowing coil current) can be fed into the drive coil L₁₁ and the current symmetrization according to the disclosure can be carried out. As with the controller R1sum in FIG. 4, the controller R_{iL11} in FIG. 6 can also be designed on the basis of a wide variety of control engineering concepts.

1-9. (canceled)

10. A method for operating an electromagnetic transport device having a long stator on which a plurality of electric drive coils is arranged, and having a number of transport units movable along the long stator, a plurality of excitation magnets being arranged on each transport unit, wherein an electrical coil current is in each case fed into a number of active drive coils of the plurality of electric drive coils, which active drive coils are involved in the movement of at least one transport unit, in order to generate a magnetic drive field, which magnetic drive field interacts with drive magnets of the at least one transport unit to move the at least one transport unit, wherein for at least one neutral point area of the long stator, in which at least one active drive coil is arranged and in which the coil currents flowing through the drive coils of the neutral point area converge in a neutral point, an area sum current is determined, which corresponds to the sum of the coil currents flowing through the drive coils of the neutral point area, and wherein a compensation current is fed into at least one active drive coil of the at least one neutral point area in addition to the coil current already flowing in the active drive coil, such that a deviation of the area sum current from a predefined area sum current setpoint is reduced.

11. The method according to claim 10, wherein a sum compensation current is determined from the area sum current, the compensation current fed into the at least one active drive coil being determined from the sum compensation current.

12. The method according to claim 11, wherein the sum compensation current is determined from the determined area sum current based on a predefined controller.

13. The method according to claim 12, wherein the controller has an integrating component.

14. The method according to claim 1, wherein a value less than 10 A, or a value less than 1 A, or a value less than 0.1 A is set as area sum current setpoint.

15. The method according to claim 1, wherein the compensation current is fed into the at least one active drive coil by means of a sequence of high-frequency current pulses.

16. The method according to claim 1, wherein the compensation current is fed out of phase with the coil current already flowing in the at least one active drive coil.

17. The method according to claim 16, wherein the phase shift is at least 45 degrees.

18. An electromagnetic transport device in the form of a long stator linear motor or planar motor, comprising a long stator on which a plurality of electric drive coils is arranged each having a coil control unit, having a number of transport units movable along the long stator, on which transport units in each case a plurality of excitation magnets is arranged, and having a supply unit, which is designed to feed an electrical coil current into a number of active drive coils of the plurality of electric drive coils, which active drive coils are involved in the movement of at least one transport unit, in order to generate a magnetic drive field, which magnetic drive field interacts with the drive magnets of the at least one transport unit to move the at least one transport unit, wherein a transport controller is further provided, which is designed to determine an area sum current for at least one neutral point area of the long stator, in which at least one active drive coil is arranged and in which the coil currents flowing through the drive coils of the neutral point area converge in a neutral point, which area sum current corresponds to the sum of the coil currents flowing through the drive coils of the neutral point area, and wherein the transport controller is designed to determine a compensation current from the area sum current, and in that the coil control unit of at least one active drive coil of the at least one neutral point area is designed to feed a compensation current into the at least one active drive coil of the at least one neutral point area in addition to the coil current already flowing in the active drive coil, such that a deviation of the area sum current from a predefined area sum current setpoint is reduced.
